(19) United States
(12) Patent Application Publication
(10) Pub. No.: US 2008/0130315 A1
(43) Pub. Date: Jun. 5, 2008

(54) BACKLIGHT ASSEMBLY AND DISPLAY DEVICE HAVING THE SAME

(76) Inventor: Ik-Sun Song, Suwon-si (KR)

Correspondence Address: F. CHAU & ASSOCIATES, LLC, 130 WOODBURY ROAD, WOODBURY, NY, 11797, US

(21) Appl. No.: 11/932,328

(22) Filed: Oct. 31, 2007

(30) Foreign Application Priority Data
Dec. 4, 2006 (KR) 10-2006-0121344

(51) Int. Cl. F21V 8/00

(52) U.S. Cl. 362/617

(57) ABSTRACT

A backlight assembly includes a light guide plate having at least one light entering plane, and a light emitting plane which crosses the light entering plane, at least one light source unit which emits light to the light entering plane, a reflecting member adjacent to an opposite surface with respect to the light emitting plane and which faces the light emitting plane of the light guide plate, and a light source cover having at least one opening, and surrounding the light source unit, wherein an edge of the light guide plate and an edge of the reflecting member is inserted through the opening. The light source cover also includes at least one stopper which protrudes from a surface of the light source cover adjacent to the reflecting member to contact the light guide plate.

### CROSS-REFERENCE TO RELATED APPLICATION

This application claims priority from Korean Patent Application No. 2006-0121344, filed on Dec. 4, 2006, the disclosure of which is incorporated herein by reference in its entirety.

### BACKGROUND OF INVENTION

1. Technical Field

The present disclosure relates to a backlight assembly and a display device having the same for improving durability.

2. Discussion of the Related Art

There are display devices of various types. Among the display devices, as semiconductor technologies have been rapidly developed, a display device having a liquid crystal display (LCD) panel is capable of being small and light, and has improved performance.

The display device having the liquid crystal display panel has features such as being capable of miniaturization, being light weight, and consuming less power to become popular as a substitute for a conventional cathode ray tube (CRT). Known liquid crystal display panels have been mounted to a medium/large sized product such as a monitor, a TV, etc., a small sized product such as a mobile phone, a personal digital assistant (PDA), a portable multimedia player (PMP), etc., and most information processing devices which need a display device.

Since the liquid crystal display panel is a light receiving type that does not emit light, the display device uses a backlight assembly supplying light to a rear surface of the liquid crystal display panel.

Generally, the backlight assembly includes various components such as a light source unit, a light source cover, a light guide plate, a reflecting member, etc. Known light source units generate a relatively large amount of heat. If the display device is used over a predetermined time, heat generated by the light source unit may heat-transform components near enough to the light source unit to be affected by the generated heat. Accordingly, quality of the display device used for a predetermined time can deteriorate.

### SUMMARY OF THE INVENTION

Accordingly, embodiments of the present invention provide a backlight assembly improving durability a display device having the backlight assembly.

A backlight assembly, in accordance with an embodiment of the present invention, comprises a light guide plate which comprises at least one light entering surface, and a light emitting surface at an angle with respect to the light entering surface, at least one light source unit which emits light to the light entering surface, a reflecting member adjacent to a surface of the light guide plate positioned opposite to and which faces the light emitting surface of the light guide plate, and a light source cover which comprises at least one opening, and surrounds the light source unit, an edge of the light guide plate and an edge the reflecting member being inserted through the opening, the light source cover comprising at least one stopper which protrudes from a surface of the light source cover adjacent to the reflecting member to contact the light guide plate.

The stopper may have an average diameter of about 0.1 mm to about 2 mm.

The stopper may comprise a cylindrical shape or a hemisphere shape.

A protruding length of the stopper may be substantially the same as the thickness of the reflecting member.

The reflecting member may comprise at least one through hole which is formed along the edge of the reflecting member which is inserted into the light source cover, and the stopper of the light source cover penetrates the through hole to contact the light guide plate.

The through hole may have an average diameter of about 0.1 mm to about 4 mm.

A display device, in accordance with an embodiment of the present invention, comprises a panel assembly which displays an image, a light guide plate which comprises a light emitting surface which faces the panel assembly, and at least one light entering surface positioned at an angle with respect to the light emitting surface, at least one light source unit which emits light to the light entering surface, a reflecting member adjacent to surface of the light guide plate positioned opposite to and which faces the light emitting surface of the light source plate, and a light source cover which comprises at least one opening, and surrounds the light source unit, an edge of the light guide plate and an edge of the reflecting member being inserted through the opening, the light source cover comprising at least one stopper which protrudes from a surface of the light source cover adjacent to the reflecting member to contact the light guide plate.

### BRIEF DESCRIPTION OF THE DRAWINGS

Exemplary embodiments of the present invention can be understood in more detail from the following descriptions taken in conjunction with the accompanying drawings, in which:

FIG. 1 is an exploded perspective view of a backlight assembly according to an exemplary embodiment of the present invention;

FIG. 2 is a partial sectional view taken along line II-II after the backlight assembly in FIG. 1 is assembled according to an exemplary embodiment of the present invention;

FIG. 3 is a partial sectional view of a backlight assembly according to an exemplary embodiment of the present invention;

FIG. 4 is an exploded perspective view illustrating a display device including the backlight assembly in FIG. 1 according to an exemplary embodiment of the present invention;

FIG. 5 is a partial sectional view illustrating a display device including a backlight assembly according to an exemplary embodiment of the present invention; and

FIG. 6 is an exploded perspective view illustrating a coupling of a light source cover and a reflecting member applied to the display device in FIG. 5 in accordance with an exemplary embodiment of the present invention.

### DETAILED DESCRIPTION OF EXEMPLARY EMBODIMENTS OF THE INVENTION

Exemplary embodiments of the present invention are described more fully hereinafter with reference to the accompanying drawings, in which exemplary embodiments of the invention are shown. This invention may, however, be embodied in many different forms and should not be construed as limited to the embodiments set forth herein.

Hereinafter, a backlight assembly of a one side edge type in which a light source unit is disposed on a single side of a light guide plate(s) will be exemplarily described. Alternatively, embodiments of the present invention may be applied to a backlight assembly of a two side edge type in which light source units are respectively disposed on two opposite sides of a light guide plate(s).

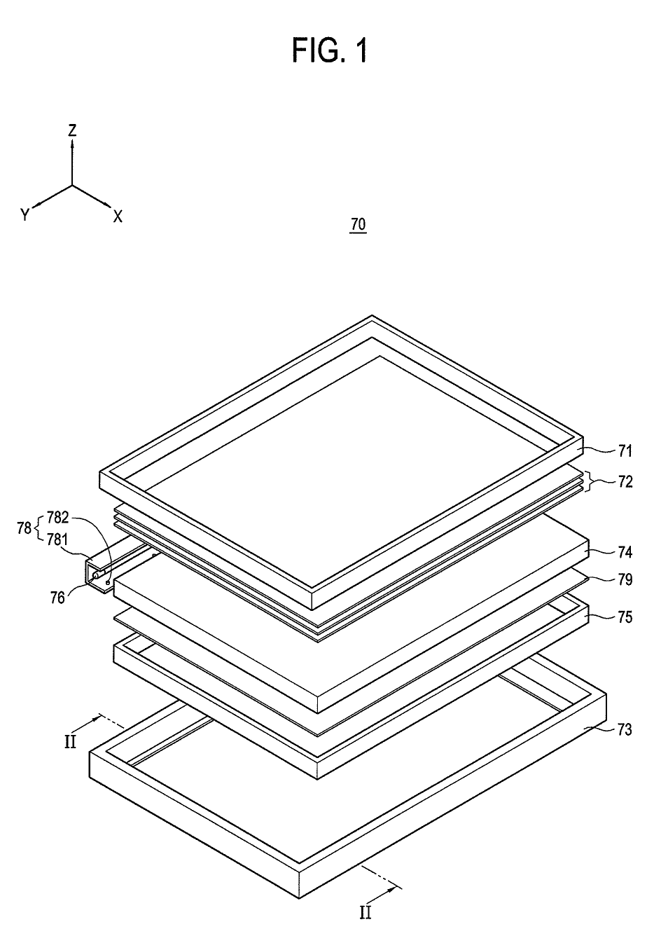

As shown in FIG. 1, a backlight assembly 70 comprises a light guide plate 74, a light source unit 76, a light source cover 78 and a reflecting member 79. Also, the backlight assembly 70 further comprises optical sheets 72, an accommodating member 75, a first supporting member 71 and a second supporting member 73.

The light guide plate 74 includes at least one light entering plane, and a light emitting plane crossing the light entering plane. The light guide plate 74 shown in FIG. 1 includes a light entering plane opposite the light source unit 76 and a light emitting plane crossing the light entering plane, for example, substantially perpendicular to the light entering plane. For example, referring to FIG. 1, a light entering surface of the light guide plate 74 is a side surface of the light guide plate opposite the light source unit 76, and a light emitting surface is a top surface of the light guide plate 74 perpendicular to the side surface. The light guide plate 74 emits light supplied through the light entering plane through the light emitting plane.

The light source unit 76 emits light to the light entering plane of the light guide plate 74. The light source unit 76 is disposed adjacent and facing the light guide plate 74. A cold cathode fluorescent lamp (CCFL) is applied as the light source unit 76. Alternatively, an external electrode fluorescent lamp (EEFL), a hot cathode fluorescent lamp (HCFL), and other known light sources may be applied as the light source unit 76. Also, a light emitting element such as a light emitting diode (LED) may be applied as the light source unit 76.

The reflecting member 79 is disposed adjacent to a surface opposite to the light emitting plane of the light guide plate 74. The reflecting member 79 reflects light supplied to the light entering plane of the light guide plate 74 toward the opposite surface of the light guide plate 74, for example, toward a bottom or rear surface of the light guide plate 74. Accordingly, light reflected by the reflecting member 79 toward the opposite surface travels through the light guide plate 74 and is emitted through the light emitting plane. The reflecting member 79 reduces loss of light, and facilitates diffusion of light, thereby improving uniformity of light emitted from the light emitting plane of the light guide plate 74.

The light source cover 78 includes at least one opening, and surrounds the light source unit 76. The light source cover 78 includes an opening facing the light entering plane of the light guide plate 74. Also, the light source cover 78 may further comprise a pair of openings positioned on sides of the light source cover at ends of the light source unit 76.

Edges of the light guide plate 74 and the reflecting member 79 are inserted into the light source cover 78 through the opening facing the light entering plane of the light guide plate 74. As a result, part of the light emitting plane of the light guide plate 74 and a rear surface edge of the reflecting member 79 respectively contact an inner surface of the light source cover 78.

The light source cover 78 comprises a cover main body 781 surrounding the light source unit 76, and at least one stopper 782 located in an inner surface of the cover main body 781 adjacent the reflecting member 79 and protruding to contact the light guide plate 74.

The inner surface of the cover main body 781 and the stopper 782 comprise a reflecting material, or are processed by reflection lamination.

The optical sheets 72 further improve a brightness property of light emitted from the light emitting plane of the light guide plate 74. Light penetrating the optical sheets 72 is diffused further uniformly, and brightness thereof intensifies. The optical sheets 72 may comprise a diffusing sheet, a prism sheet, a brightness intensifying sheet, a protecting sheet and/or other various function sheets.

The accommodating member 75 accommodates the light guide plate 74, the light source unit 76, the light source cover 78, the reflecting member 79 and the optical sheets 72. The first supporting member 71 is coupled with the accommodating member 75 to fix the light guide plate 74, the light source unit 76, the light source cover 78, the reflecting member 79, and the optical sheets 72 accommodated in the accommodating member 75.

As shown in FIG. 1, the accommodating member 75 and the first supporting member 71 are used. Alternatively, the first supporting member 71 may be omitted. If the first supporting member 71 is omitted, the accommodating member 75 may be employed to additionally function as the first supporting member 71.

The second supporting member 73 is coupled along side and rear edges of the accommodating member 75. The second supporting member 73 reinforces the strength of the accommodating member 75 to prevent the accommodating member 75 from being bent or twisted. The second supporting member 73 protects the accommodating member 75 from deformation. The second supporting member 73 may be omitted like the first supporting member 71.

An inverter circuit substrate (not shown) is disposed in a rear surface of the accommodating member 75. The inverter circuit substrate is electrically connected with the light source unit 76 through a wire and a socket. The inverter circuit substrate transforms an external power to be a predetermined voltage level, and then transmits it to the light source unit 76 to drive the light source unit 76.

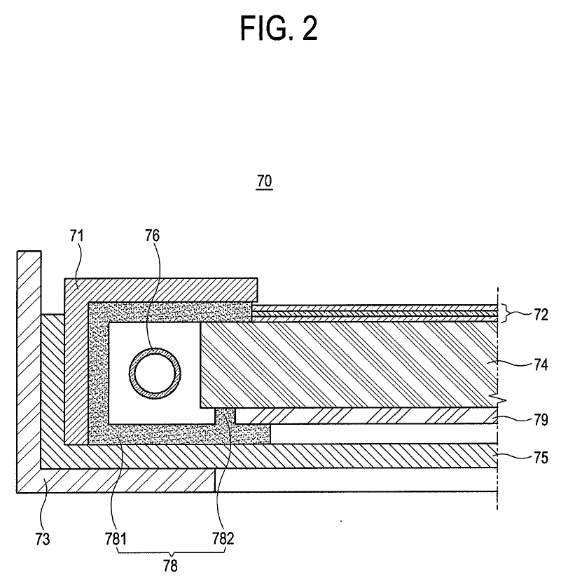

The backlight assembly 70 according to an exemplary embodiment of the present invention will be described in more detail by referring to FIG. 2.

As shown in FIG. 2, the stopper 782 of the light source cover 78 maintains a predetermined interval between part of the inner surface of the cover main body 781 adjacent to the reflecting member 79 and the light guide plate 74. The stopper 782 is formed in a cylindrical shape. A protruding length of the stopper 782 is essentially the same as the thickness of the reflecting member 79. That is, the interval maintained by the stopper 782 is essentially the same as the thickness of the reflecting member 79. If the length of the stopper 782 is larger than the thickness of the reflecting member 79, a gap is generated between the reflecting member 79 and the light guide plate 74. If a gap is generated between the reflecting member 79 and the light guide plate 74, uniformity of light generated in the light source unit 76 and emitted through the light guide plate 74 deteriorates.

The light guide plate 74 and the reflecting member 79 can be formed of known materials.

With this configuration, the backlight assembly 70 can have improved durability. The light source cover 78 may contract due to heat generated by the light source unit 76. As a result, the opening of the light source cover 76 narrows so that the light source cover 78 can press the light guide plate 74 and the reflecting member 79. If the light source cover 78 presses an edge of the reflecting member 79 inserted through the opening, the pressed reflecting member 79 wrinkles. Since the reflecting member 79 can be thinner and weaker than the light guide plate 74, the reflecting member 79 is prone to be deformed by pressure. Accordingly, in the backlight assembly 70, a brightness uniformity of light emitted deteriorates due to a deformed part of the reflecting member 79. Accordingly, quality of the backlight assembly 70 may deteriorate. However, since the stopper 782 of the light source cover 78 ensures space corresponding to the thickness of the reflecting member 79, although the light source cover 78 contracts, the reflecting member 79 is prevented from being pressed by the light source cover 78. Accordingly, durability of the backlight assembly 70 can be improved. Particularly, quality of the backlight assembly 70 can be prevented from being deteriorated by heat generated in the light source unit 76.

Also, the stopper 782 has an average diameter of about 0.1 mm to about 2 mm. Alternatively, if the stopper is formed in a cubic or three-dimensional rectangular shape, the stopper may have an average width of about 0.1 mm to about 2 mm.

If the diameter or width of the stopper 782 is smaller than about 0.1 mm, the stopper 782 may not have a proper strength necessary to maintain an interval corresponding to the thickness of the reflecting member 79. That is, when the light source cover 78 contracts, it is difficult to efficiently prevent the reflecting member 79 from being pressed by the light source cover 78. If the diameter or width of the stopper 782 is larger than about 2 mm, interference of light emitted from the light source unit 76 may intensify to deteriorate uniformity of light emitted via the light guide plate 74.

Also, the light source cover 78 comprises a plurality of stoppers 782 to be proper to protect the reflecting member 79 from pressure due to a contraction of the light source cover 78.

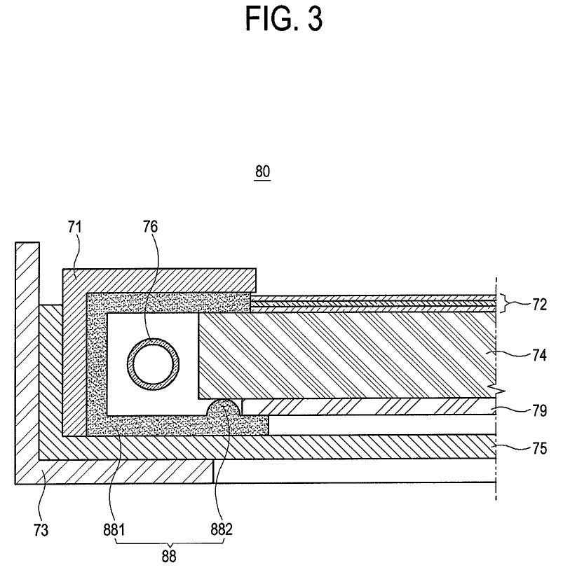

Hereinafter, an exemplary embodiment of the present invention will be described by referring to FIG. 3.

As shown in FIG. 3, a light source cover 88 comprises a cover main body 881 surrounding the light source unit 76, and at least one stopper 882 protruding to contact with the light guide plate 74 in an inner surface of the cover main body 881 adjacent to the reflecting member 79. Here, the stopper 882 has a hemisphere shape.

With this configuration, if the stopper 882 has the hemisphere shape, interference of light emitted from the light source unit 76 can be minimized. Also, the strength of the stopper 882 can be improved. That is, the stopper 882 can minimize interference of light emitted from the light source unit 76, and more stably maintain a specific interval between the inner surface of the cover main body 881 adjacent to the reflecting member 79 and the light guide plate 74.

Accordingly, durability of the backlight assembly 80 can be further improved.

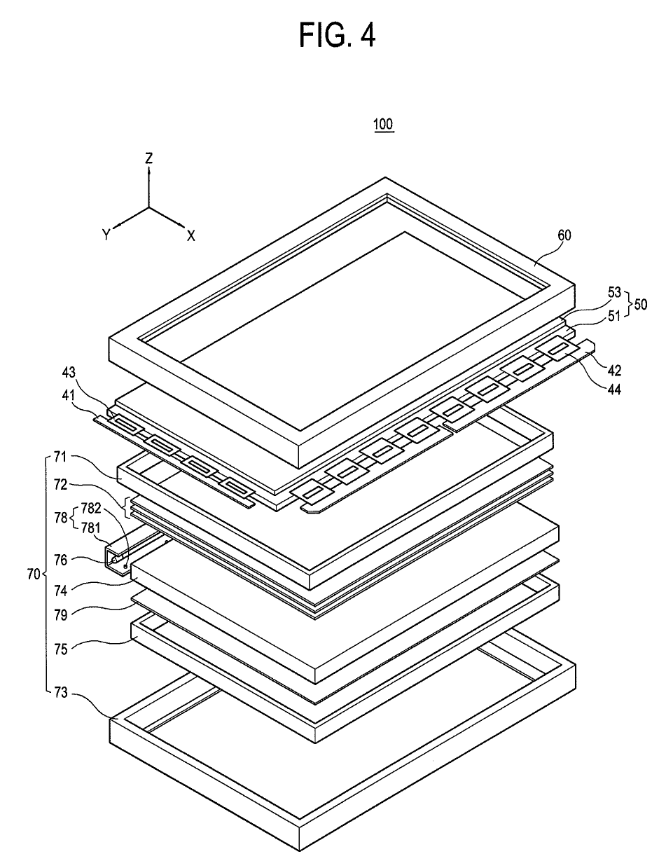

FIG. 4 illustrates a display device 100 including the backlight assembly in FIG. 1.

In FIG. 4, a liquid crystal display panel is exemplarily illustrated as a panel assembly 50 applied to a display device 100. Alternatively, a display panel of other types may be applied thereto.

As shown in FIG. 4, a display device 100 comprises a backlight assembly 70 supplying light, and a panel assembly 50 receiving the light to display an image. The display device 100 further comprises a stationary member 60 fixedly supporting the panel assembly 50 with respect to the backlight assembly 70, and may further comprise other necessary parts.

Also, the display device 100 comprises a plurality of driving integrated circuit chip packages 43 and 44, and driving printed circuit substrates 41 and 42 electrically connected with the panel assembly 50 to transmit driving signals. The driving integrated circuit chip packages 43 and 44 are provided by a chip on film package (COF) or a tape carrier package (TCP).

The driving integrated circuit chip packages 43 and 44 comprise gate driving integrated circuit chip packages 43 and data driving integrated circuit chip packages 44. The gate driving integrated circuit chip packages 43 are attached to a first edge of the panel assembly 50 to supply a gate signal to the panel assembly 50. The data driving integrated circuit chip packages 44 are attached to a second edge of the panel assembly 50 adjacent to the first edge to supply other signals including a gate signal to the panel assembly 50.

The panel assembly 50 comprises a first display panel 51, and a second display panel 53 facing the first display panel 51, and a liquid crystal layer (not shown) is interposed between the first and second display panels 51, 53. The first display panel 51 is a rear substrate, and the second display panel 53 is a front substrate. The second display panel 53 is smaller than the first display panel 51. First sides of the driving integrated circuit chip packages 43 and 44 are attached to an edge of the first display panel 51 which is not overlapped with the second display panel 53 to be connected with the panel assembly 50. A second side of at least one of the driving integrated circuit chip packages 43 and 44 is connected with the driving printed circuit substrates 41 and 42.

In FIG. 4, all driving integrated circuit chip packages 43 and 44 are connected with the driving printed circuit substrates 41 and 42. Alternatively, less than all of the driving integrated circuit chip packages 43 and 44 are connected with the driving printed circuit substrates 41 and 42. For example, a driving printed circuit substrate 41 connected with the gate driving integrated circuit chip package 43 may be omitted as necessary. In this alternative embodiment, a first side of the gate driving integrated circuit chip package 43 is connected with the panel assembly 50, and a second side thereof is not connected to the driving printed circuit substrate 41.

Polarizing plates are respectively attached to a front surface of the second display panel 53 and a rear surface of the first display panel 51 to linearly polarize a visible ray supplied from the backlight assembly 70.

A plurality of thin film transistors (TFT), color filters, pixel electrodes, common electrodes, and other known elements in the art are formed in the first display panel 51 and the second display panel 53. The liquid crystal layer is disposed between the pixel electrode and the common electrode.

With this configuration, if the thin transistor, a switching element, is turned on, an electric field is formed between the pixel electrode and the common electrode. By this electric field, a liquid crystal arrangement angle of the liquid crystal molecules in the liquid crystal layer disposed between the first display panel 51 and the second display panel 53 is changed, and accordingly, a desired image can be obtained by varying light transmittance.

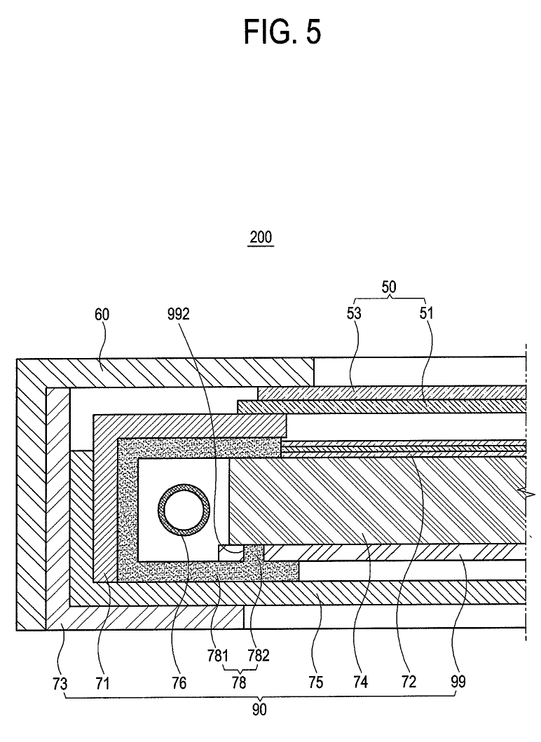

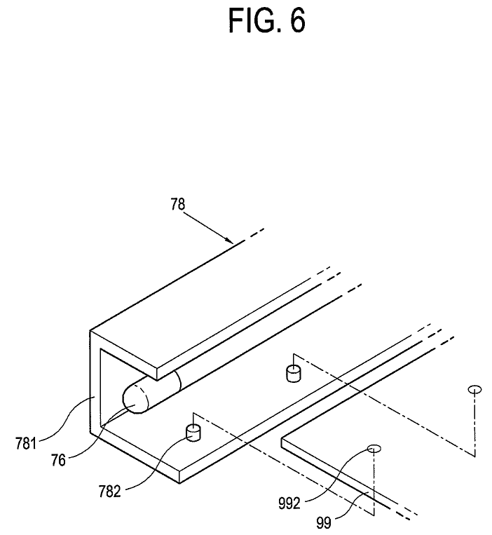

An exemplary embodiment of the present invention will be described by referring to FIGS. 5 and 6.

As shown in FIG. 5, a reflecting member 99 of a backlight assembly 90 provided to a display device 200 according to an exemplary embodiment of the present invention comprises at least one through hole 992 formed along an edge thereof inserted into a light source cover 78. The number of through holes 992 correspond to the number of stoppers 782 of the light source cover 78. The stopper 782 of the light source cover 78 penetrates the through hole 992 to contact with a light guide plate 74.

The stopper 782 can maintain a specific interval between an inner surface of a cover main body 781 adjacent to the reflecting member 99 and the light guide plate 74, and fix the reflecting member 99.

Since the length of the stopper 782 is essentially the same as the thickness of the reflecting member 99, the reflecting member 99 may be inserted to an opening of the light source cover 78 with some movement. However, since the stopper 782 penetrates the through hole 992 of the reflecting member 99, the reflecting member 99 can be fixed, thereby preventing movement.

Accordingly, the backlight assembly 90 provided to the display device 200 can have an improved durability, and the reflecting member 99 can be stably supported.

FIG. 6 illustrates a coupling between the stopper 782 of the light source cover 78 and the through hole 992 of the reflecting member 99. As shown in FIG. 6, the stopper 782 is inserted through the through hole 992 of the reflecting member 99.

The through hole 992 has a diameter of about 0.1 mm to about 0.4 mm. That is, the diameter of the through hole 992 is essentially the same as the diameter of the stopper 782, or larger than the diameter of the stopper 782 by a predetermined range. If the through hole 992 is excessively larger than the stopper 782, it the stopper 782 may not be able to prevent the reflecting member 99 from moving.

The embodiments of the present invention provide a backlight assembly and a display device having the same improving durability.

A stopper of a light source cover ensures a space to stably support a reflecting member. Accordingly, if the light source cover contracts due to heat generated by a light source unit, the light source cover is prevented from pressing the reflecting member.

Accordingly, durability of the backlight unit and the display device having the same can be improved, thereby preventing deterioration of quality.

Also, the stopper of the light source cover can stably support the reflecting member.

Although illustrative embodiments of the present invention have been described herein with reference to the accompanying drawings, it is to be understood that the present invention should not be limited to those precise embodiments and that various other changes and modifications may be affected therein by one of ordinary skill in the related art without departing from the scope or spirit of the invention. All such changes and modifications are intended to be included within the scope of the invention as defined by the appended claims.

What is claimed is:

1. A backlight assembly, comprising:
a light guide plate comprising at least one light entering surface, and a light emitting surface;
at least one light source unit which emits light to the light entering surface;
a reflecting member positioned adjacent to a surface positioned opposite to the light emitting surface of the light guide plate; and
a light source cover comprising:
at least one opening, wherein the light source cover partially surrounds the light source unit, an edge of the light guide plate and an edge of the reflecting member being inserted through the opening, and
at least one stopper protruding from a surface of the light source cover adjacent.

2. The backlight assembly according to claim 1, wherein the stopper has an average diameter of about 0.1 mm to about 2 mm.

3. The backlight assembly according to claim 2, wherein the stopper comprises a cylindrical shape.

4. The backlight assembly according to claim 2, wherein the stopper comprises a hemisphere shape.

5. The backlight assembly according to claim 1, wherein a protruding length of the stopper is substantially the same as the thickness of the reflecting member.

6. The backlight assembly according to claim 1, wherein:
the reflecting member comprises at least one through hole formed along the edge of the reflecting member which is inserted into the light source cover, and
the stopper penetrates the through hole to contact the light guide plate.

7. The backlight assembly according to claim 2, wherein:
the reflecting member comprises at least one through hole formed along the edge of the reflecting member which is inserted into the light source cover, and
the stopper penetrates the through hole to contact the light guide plate.

8. The backlight assembly according to claim 7, wherein the through hole has an average diameter of about 0.1 mm to about 4 mm.

9. The backlight assembly according to claim 6, wherein the through hole has an average diameter of about 0.1 mm to about 4 mm.

10. A display device, comprising:
a panel assembly which displays an image;
a light guide plate comprising a light emitting surface facing the panel assembly, and at least one light entering surface;
at least one light source unit which emits light to the light entering surface;
a reflecting member positioned adjacent to a surface positioned opposite to the light emitting surface of the light guide plate and comprising at least one through hole; and
a light source cover comprising:
at least one opening, wherein the light source cover partially surrounds the light source unit, an edge of the light guide plate and an edge of the reflecting member being inserted through the opening, and
at least one stopper protruding from a surface of the light source cover adjacent to the reflecting member to contact the light guide plate,
wherein the through hole is formed along the edge which is inserted into the light source cover, and the stopper penetrates the through hole to contact the light guide plate.

11. The display device according to claim 10, wherein the stopper has an average diameter of about 0.1 mm to about 2 mm.

12. The display device according to claim 11, wherein the stopper comprises a cylindrical shape.

13. The display device according to claim 11, wherein the stopper comprises a hemisphere shape.

14. The display device according to claim 10, wherein a protruding length of the stopper is substantially the same as the thickness of the reflecting member.

15. The display device according to claim 14, wherein:
the reflecting member comprises at least one through hole formed along the edge which is inserted into the light source cover, and
the stopper penetrates the through hole to contact the light guide plate.

16. The display device according to claim 10, wherein:
the reflecting member comprises at least one through hole formed along the edge which is inserted to the light source cover, and
the stopper penetrates the through hole to contact the light guide plate.

17. The display device according to claim 16, wherein the through hole has an average diameter of about 0.1 mm to about 4 mm.

18. The display device according to claim 10, wherein the through hole has an average diameter of about 0.1 mm to about 4 mm.

19. The display device according to claim 15, wherein the through hole has an average diameter of about 0.1 mm to about 4 mm.
